(19) United States
(12) Patent Application Publication
(10) Pub. No.: US 2008/0055045 A1
(43) Pub. Date: Mar. 6, 2008

(54) RFID TAG INCLUDING A THREE-DIMENSIONAL ANTENNA

(75) Inventors: Michael D. Swan, Lake Elmo, MN (US); Daniel R. Fronek, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/838,356

(22) Filed: Aug. 14, 2007

Related U.S. Application Data
(60) Provisional application No. 60/824,173, filed on Aug. 31, 2006.

(51) Int. Cl. H04B 7/00

(52) U.S. Cl. 340/10.1

(57) ABSTRACT

A radio frequency identification (RFID) tag comprises an antenna folded into a three-dimensional configuration defining at two antenna layers that reside in different planes. Spacer material separates at least two of the antenna layers.

### CROSS REFERENCE TO RELATED APPLICATION

This application claims the benefit of U.S. Provisional Patent Application No. 60/824173, filed Aug. 31, 2006, the disclosure of which is incorporated by reference herein in its entirety.

### TECHNICAL FIELD

The invention relates to radio frequency identification (RFID) systems for article management and, more specifically, to RFID tags.

### BACKGROUND

Radio frequency identification (RFID) technology has become widely used in virtually every industry, including transportation, manufacturing, waste management, postal tracking, airline baggage reconciliation, and highway toll management. A typical RFID system includes a plurality of RFID tags, at least one RFID reader (also referred to as an “interrogator”) or detection system having an antenna for communicating with the RFID tags, and a computing device to control the RFID reader. The RFID reader includes a transmitter that may provide energy or information to the tags, and a receiver to receive identity and other information from the tags. The computing device processes the information obtained by the RFID reader.

In general, the information received from an RFID tag is specific to the particular application, but often provides an identification for an article to which the tag is fixed. Exemplary articles include manufactured items, books, files, animals or individuals, or virtually any other tangible articles. Additional information may also be provided for the article. The tag may be used during a manufacturing process, for example, to indicate a paint color of an automobile chassis during manufacturing or other useful information.

The transmitter of the RFID reader outputs radio frequency (RF) signals through the antenna to create an electromagnetic field that enables the tags to return an RF signal carrying the information. In some configurations, the transmitter initiates communication, and makes use of an amplifier to drive the antenna with a modulated output signal to communicate with the RFID tag. In other configurations, the RFID tag receives a continuous wave signal from the RFID reader and initiates communication by responding immediately with its information.

A conventional tag may be an “active” tag that includes an internal power source, or a “passive” tag that is energized by the RF field created by the RFID reader (typically by inductive coupling). In either case, the tags communicate using a pre-defined protocol, allowing the RFID reader to receive information from one or more tags. The computing device serves as an information management system by receiving the information from the RFID reader and performing some action, such as updating a database. In addition, the computing device may serve as a mechanism for programming data into the tags via the transmitter.

### SUMMARY

In general, the invention is directed to a radio frequency identification (RFID) tag that includes an antenna that is folded into a three-dimensional (3D) configuration to define at least two antenna layers that reside in different planes. A spacer material separates the antenna layers. In one embodiment, a spacer material also separates the antenna from a surface on which the RFID tag is placed, which may help reduce adverse effects from a conductive surface. Conductive surfaces may be found, for example, in aerospace applications.

The RFID tag in accordance with the invention may be useful for applications in which there is limited space to apply the RFID tag to an article, but a desire to increase a read range of the RFID tag. In one example, it was found that given two RFID tags having substantially similar contact surface areas, the RFID tag including a folded antenna exhibited a greater read range than the RFID tag including an unfolded antenna. This is at least partially attributable to the fact that the folded antenna had a greater surface area of antenna per contact surface area of the RFID tag than the unfolded antenna. Folding the antenna enables the antenna surface area per contact surface area of the RFID tag to be increased, and thus enables read range to be increased without increasing contact surface area of the RFID tag.

The RFID tag may also be useful for applications in which it is desirable to reduce a weight of the RFID tag because of the ability to incorporate an antenna having a given surface area into a relatively compact RFID tag.

In one embodiment, the invention is directed to an RFID tag comprising a three-dimensional (3D) antenna comprising at least a first antenna layer and a second antenna layer and a layer of spacer material between the first and second layers of the antenna. The first antenna layer and the second antenna layer define two-dimensional (2D) conductive surfaces substantially residing in different planes of the RFID tag. For such an RFID tag, if subjected to an electromagnetic field, electrical current flows between the first antenna layer and the second antenna layer when the tag is in the presence of an electromagnetic field.

In another embodiment, the invention is directed to a system comprising an RFID tag and a reader unit for interrogating the RFID tag to obtain information from the RFID tag. The RFID tag comprises a contact surface having a contact surface area, an antenna folded into a three-dimensional configuration to define a plurality of antenna portions, and at least one layer of electrically nonconductive spacer material separating at least two of the antenna portions. An antenna surface area of the antenna is greater than the contact surface area of the contact surface of the RFID tag.

In another embodiment, the invention is directed to a method for forming an RFID tag. The method comprises folding an antenna to define at least two antenna layers, each antenna layer defining a two-dimensional (2D) conductive surface, and separating the at least two antenna layers with a spacer material.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of an exemplary radio frequency identification (RFID) system for locating a plurality of articles.

FIG. 2 is a schematic perspective view of one embodiment of an RFID tag in accordance with the invention, which includes an adhesive layer, outer layer, integrated circuit (IC) chip, antenna, and spacer layer.

FIG. 3 is a schematic diagram of a testing system for testing a read range of an RFID tag.

FIG. 4 is a graph demonstrating a relationship between a surface area of an antenna of an RFID tag and a read range of the RFID tag when the RFID tag is placed on an electrically nonconductive surface.

FIG. 5 is a graph demonstrating a relationship between a surface area of an antenna of an RFID tag and a read range of the RFID tag when the RFID tag is placed on an electrically conductive surface.

FIG. 6 illustrates a schematic perspective view of a baseline RFID tag that includes a substantially two-dimensional antenna, where a read range of the baseline RFID tag was tested in a first example.

FIGS. 7A-7D illustrate schematic cross-sectional views of an RFID tag in accordance with the invention, which incorporates a folded antenna.

FIG. 8 is a graph illustrating a relationship between a total thickness one or more spacer layers disposed between first and second layers of the folded antenna of the RFID tag of FIGS. 7A-7D and a read range of the RFID tag.

FIG. 9 is a graph illustrating a relationship between a distance between the second layer of the folded antennas of FIGS. 7A-7D and a conductive testing surface.

FIGS. 10A-10D illustrate four example antenna configurations in accordance with the invention.

FIGS. 11A-11C illustrate a technique for constructing an RFID tag in accordance with the invention.

FIG. 12 is a graph illustrating the results of a fourth example, and illustrates a relationship between a thickness of a spacer material disposed between layers of a folded antenna and a read range of RFID tag incorporating the folded antenna.

FIG. 13 is a schematic cross-sectional view of another embodiment of an RFID tag, which includes a folded antenna defining three layers.

FIG. 14 is a graph illustrating the results of a fifth example testing a relationship between a spacing between second and third layers of the folded antenna of FIG. 13 and a read range of the RFID tag of FIG. 13.

### DETAILED DESCRIPTION

The invention relates to a radio frequency identification (RFID) tag that includes an antenna folded into a three dimensional configuration to define at least two portions that substantially reside in different planes. The antenna may be an ultra high frequency (UHF) antenna that operates in a frequency range of 300 megahertz (MHz) to about 30 gigahertz (GHz). The antenna is folded into a (3D) configuration in order to obtain the benefits of an antenna having a large surface area, namely a long read range, while maintaining a relatively compact RFID tag structure. A read range is generally a communicating operating distance between a reader and an RFID tag. A “3D configuration” indicates that the antenna lies in three dimensions, and referencing orthogonal x-y-z axes for ease of description, the antenna has an x-axis component, y-axis component, and a z-axis component.

As described herein, use of a folded antenna within the RFID tag may increase a read range of the RFID tag, while at the same time, maintaining a relatively compact structure. That is, by folding an antenna to define one or more antenna portions (or layers), an antenna having a given surface area may be incorporated into a more compact RFID tag structure than a conventional, substantially two-dimensional (2D) antenna having the same surface area. In contrast to the 3D antenna described herein, a two-dimensional (2D) conventional antenna substantially extends in a single plane and a profile of the antenna does not significantly protrude from the plane.

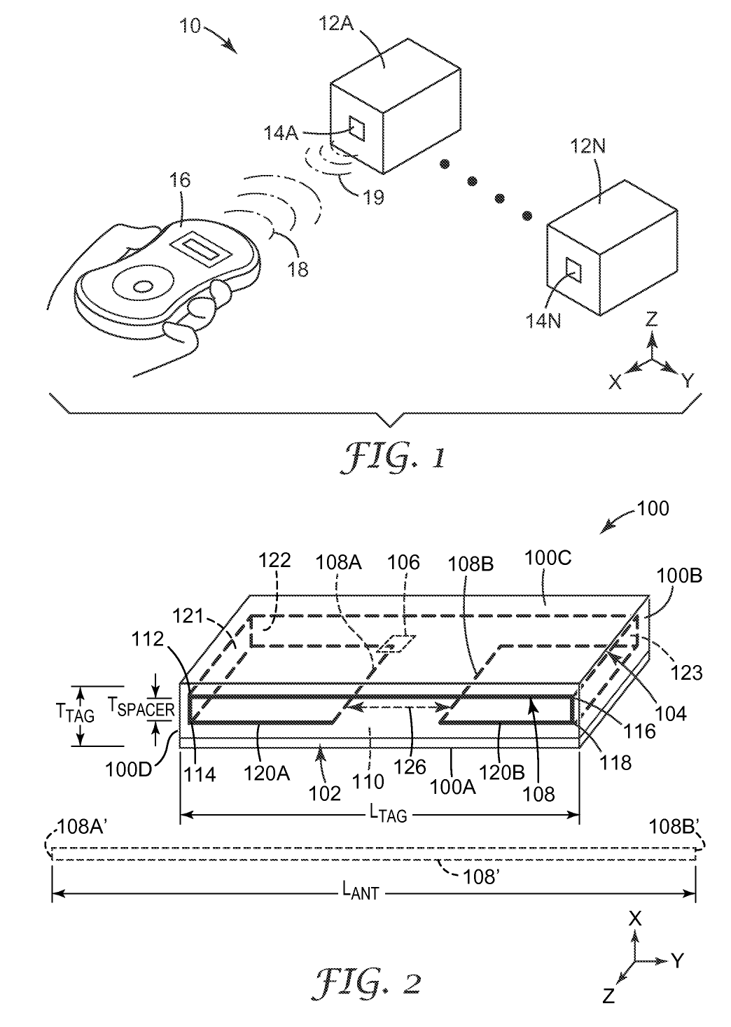

FIG. 1 is a perspective view of an exemplary radio frequency identification (RFID) system 10 for locating a plurality of articles 12A-12N (collectively “articles 12”). RFID system 10 includes RFID tags 14A-14N attached to articles 12A-12N and a portable RFID reader 16, which is adapted to interrogate and obtain data from each of RFID tags 14A-14N (collectively, “RFID tags 14”). Examples of articles 12 to be located include both electrically conductive and nonconductive aerospace components. RFID tags 14A-14N each include a length that is measured along the y-axis, a width that is measured along the z-axis, and a thickness that is measured along the x-axis. The orthogonal x-y-z axes shown in FIG. 1 are referenced to aid description of the invention, and are not intended to limit the scope of the invention in any way. A surface of each of RFID tags 14A-14N in the y-z plane is adjacent to the respective article 12A-12N and defines a “contact surface area.” In one embodiment, a y-z plane of each of RFID tags 14 is attached to the respective article 12A-12N, such as with a pressure sensitive adhesive, tape or foam, a mechanical attachment means, or any other suitable mode of attachment.

The placement of RFID tags 14 on the respective articles 12A-12N enables RFID reader 16 to associate a description of an article 12A-12N with the respective RFID tag 14A-14N via radio frequency (RF) signals 18 and 19. For example, the placement of RFID tag 14A on article 12A enables a person to utilize handheld RFID reader 16 to associate a description or other information related to article 12A with RFID tag 14A via RF signals 18 and 19. In an alternate embodiment, reader 16 may be incorporated into an automated or semi-automated process and a person does not necessarily need to utilize reader 16. Reader 16 may interrogate RFID tag 14A by generating RF signal 18, which is received by an antenna disposed within RFID tag 14A. The signal energy typically carries both power and commands to RFID tag 14A. RFID tag 14A antenna receives the RF energy radiated by reader 16 and, if the field strength of the RF signal 18 exceeds a read threshold, the RFID tag is energized and responds by radiating RF signal 19. That is, the antenna enables RFID tag 14A to absorb energy sufficient to power an IC chip coupled to the antenna. Typically in response to one or more commands, the IC chip drives the antenna to output an RF response to be detected by reader 16. The response may consist of an RFID tag identifier, which may match an identifier stored within a database of RFID handheld reader 16 or an RFID management system (not shown). Alternatively, the response may consist of the transmittal of data from RFID tags 14 to reader 16. Reader 16 may interface with a data communication port of the RFID management system for communication of data between the reader 16 and the RFID management system. The person may utilize RFID reader 16 to locate one or more articles 12A-12N by pointing RFID reader 16 at the respective RFID tags 14. Alternatively, one or more articles 12 may pass in front of RFID reader 16.

While RFID reader 16 is shown in FIG. 1 as a hand held reader, in alternate embodiments, RFID reader 16 may be any suitable reader, such as a fixed reader. In further alternate embodiments, RFID reader 16 may display, translate and/or use data from RFID tags 14 in addition to or instead of merely associating a description or other information related to an article 12 with a respective RFID tag 14.

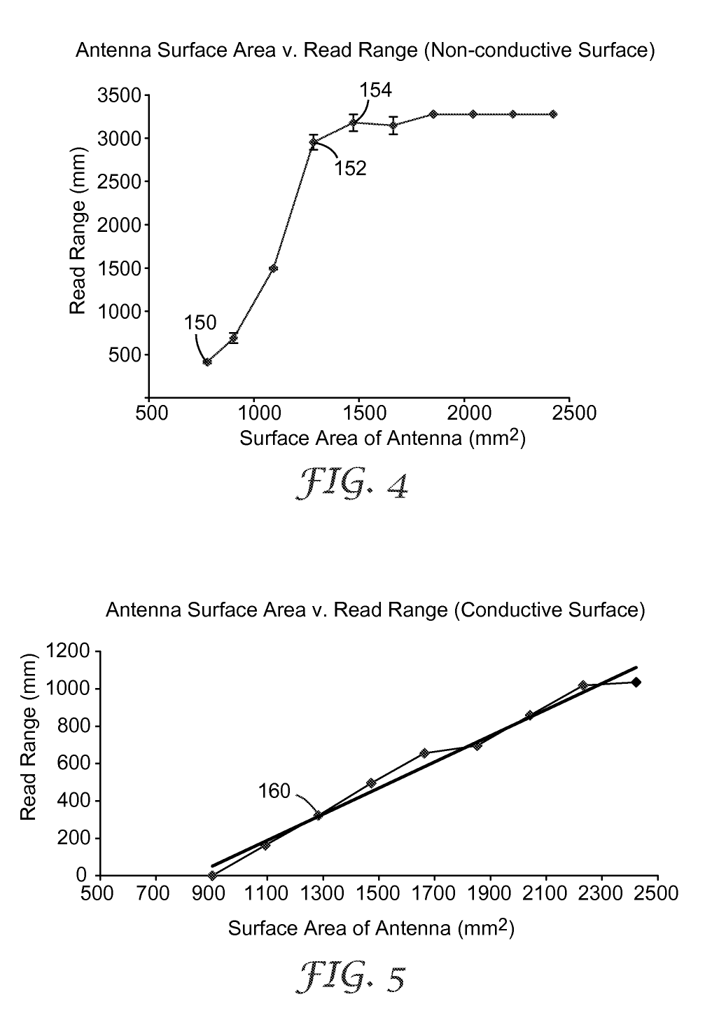

As described in detail below, one or more of RFID tags 14 include an antenna that is folded into a 3D configuration. RFID tags 14 also include an insulator or spacer material separating the different surfaces (or layers) of the antenna. As discussed below in reference to FIG. 4, experimental results indicate that the greater the surface area of the antenna disposed within each of RFID tags 14, the longer the read range of the respective RFID tag 14. In the example of FIG. 1, the antenna of each of the RFID tags 14 is folded in order to incorporate an antenna having a relatively large surface area into a relatively compact RFID tag structure. As with the embodiments shown in FIGS. 2, 7A-7D, 10A-10D, and 13, the antennas of each RFID tag 14 is folded in a x-axis direction (i.e., in a direction of a thickness of the respective RFID tag 14A-14N). Of course, in alternate embodiments, the antennas of each RFID tag 14A-14N may be folded in the y-axis and/or z-axis directions as long as there is some folding in the x-axis direction.

FIG. 2 is a schematic perspective view of an example 3D RFID tag 100 that includes adhesive layer 102, outer layer 104, integrated circuit (IC) chip 106 (in phantom lines), a 3D antenna 108, and spacer material 110, which may be formed from one or more separate layers of spacer material. In one embodiment, spacer layer 110 is about 0.5 mm to about 10 mm thick, however in other embodiments, spacer layer 110 may be any suitable thickness. RFID tag 100 may be a part of an RFID system, such as RFID system 10 of FIG. 1. In FIG. 2, four surfaces 100A, 100B, 100C, and 100D of RFID tag 100 are shown. Surfaces 100A and 100C are substantially parallel to each other and each have length L_{TAG}, which is measured along the y-axis direction (orthogonal x-y-z axes are provided in FIG. 2). Surfaces 100B and 100D are substantially parallel to each other and each have a length generally equal to thickness T_{TAG} of RFID tag 100, which is measured along the x-axis direction. In other embodiments, RFID tag 100 may be modified such that surfaces 100A and 100C are not substantially equal in length and/or parallel. RFID tag 100 may also be modified such that surfaces 100B and 100D are not substantially equal in thickness and/or parallel.

Adhesive layer 102 may be used to attach RFID tag 100 to a surface of an article, and may be formed of any suitable adhesive, which may depend on the particular application of RFID tag 100. For example, in some embodiments, adhesive layer 102 may be a pressure sensitive adhesive or tape. In alternate embodiments, RFID tag 100 may be attached to a surface of an article with another suitable mode of attachment, such as a mechanical attachment means. Adhesive layer 102 defines an article contact surface 100A of RFID tag 100, which extends in the y-z plane (where the z-axis is substantially perpendicular to the plane of the image of FIG. 2). Outer layer 104 helps protect IC chip 106 and antenna 108 from contaminants, such as environmental debris, and may also be rigid to help protect IC chip 106 and antenna 108 from physical damage. Outer layer 104 may be formed of any suitable material, such as a rigid material (e.g., glass or ceramic) or a flexible material (e.g., polyimide). In other embodiments, outer layer 104 may also extend over one or more sides, such as 100B, 100C or 100D. Furthermore, while antenna 108 is shown in FIG. 2 to be separated in the x-axis, y-axis, and z-axis directions from outer layer 104 (e.g., by spacer material 110), in other embodiments, antenna 108 may be directly adjacent to outer layer 104.

IC (integrated circuit) chip 106 is electrically coupled to antenna 108, and provides a primary identification function for RFID tag 100. For example, IC chip 106 may be coupled to antenna 108, either directly or by using vias or crossovers, and may be embedded within RFID tag 100 or mounted as a surface mounted device (SMD).

IC chip 106 may include firmware and/or circuitry to store RFID tag 100 unique identification and other desirable information, interpret and process commands received from the interrogation hardware, respond to requests for information by the interrogator (e.g., reader 16 of FIG. 1), and to resolve conflicts resulting from multiple tags responding to interrogation simultaneously. Optionally, IC chip 106 may be responsive to commands (read/write) for updating the information stored in an internal memory as opposed to just reading the information (read only). Integrated circuits suitable for use in IC chip 106 of RFID tag 100 include those available from Texas Instruments located in Dallas, Tex. (in their Gen 2 IC line of products), Philips Semiconductors located in Eindhoven, Netherlands (in their I-CODE line of products), and ST Microelectronics located in Geneva, Switzerland, among others.

The specific properties of antenna 108 depend on the desired operating frequency of the RFID tag 100. Antenna 108 receives radio frequency (RF) energy radiated by an interrogator (e.g., reader 16 of FIG. 1). For example, the RF signal emitted by the interrogator may be an ultra high frequency (UHF) RF signal, which typically refers to a frequency in a range of about 300 megahertz (MHz) to about 3 gigahertz (GHz). This RF energy carries both power and commands to RFID tag 100. In one embodiment, antenna 108 absorbs RF energy from the interrogator and operates to convert the energy to power IC chip 106, which provides the response to be detected by the interrogator. Thus, the properties or characteristics of antenna 108 should be matched to the system in which it is incorporated. Antenna 108 may be formed of any suitable electrically conductive material, such as, but not limited to, metallic materials including copper, aluminum, metal alloys, and magnetic metals, such as Permalloy.

Antenna 108 extends between proximal end 108A and distal end 108B. A fully extended 2D antenna 108′ is shown in FIG. 2 in phantom lines and is a linear representation of 3D antenna 108. A total length of antenna 108 L_{ANT} from proximal end 108A to distal end 108B is greater than length L_{TAG} of RFID tag 100. In one embodiment, antenna 108 has a width (measured in the y-z plane) substantially equal to the width of RFID tag 100. Because antenna 108 is folded in regions 112, 116, 114, and 118 (which thereby define first, second, third, and fourth folds, respectively), antenna 108 is able to fit within RFID tag 100 without requiring length L_{TAG} of RFID tag 100 to equal length L_{ANT} of antenna 108 in order to accommodate antenna 108. Length L_{ANT} of antenna 108 is proportional to a surface area of antenna 108 because the surface area is generally equal to length L_{ANT} multiplied by a width (not shown) of antenna 108. Thus, by folding antenna 108, a surface area of antenna 108 may be increased or maximized in a limited space, which allows RFID tag 100 to maintain a relatively compact structure and reduce or minimize an area of contact surface 100A. The contact surface 100A area of RFID tag 100 may also be referred to “footprint” area of RFID tag 100.

In this example, antenna 108 is a continuous planar antenna that is folded in regions 112, 114, 116, and 118, thereby substantially defining portions 120-123 that define substantially two-dimensional conductive surfaces. In the embodiment shown in FIG. 2, portion 120 includes subportions 120A and 120B, which lie in substantially the same plane. In addition, portions 120 and 122 are substantially parallel and lie in separate planes, while portions 121 and 123 are substantially parallel and lie in separate planes. In alternate embodiments, portions 120A, 120B, and 121-123 of antenna 108 may be otherwise arranged. For example, in one embodiment, subportions 120A and 120B of portion 120 may reside in different planes. Portions 120 and 122 may be referred to as “layers” or “surfaces” of antenna 108.

Gap 126 between proximal end 108A and distal end 108B of antenna 108 within subportion 120 introduces an impedance tuning mechanism into antenna 108. In one embodiment, RFID tag 100 may include a tuning element (not shown) to match an impedance of antenna 108 to the impedance of IC chip 106. However, in alternate embodiments, an impedance of IC chip 106 and antenna 108 may be matched using any other suitable means.

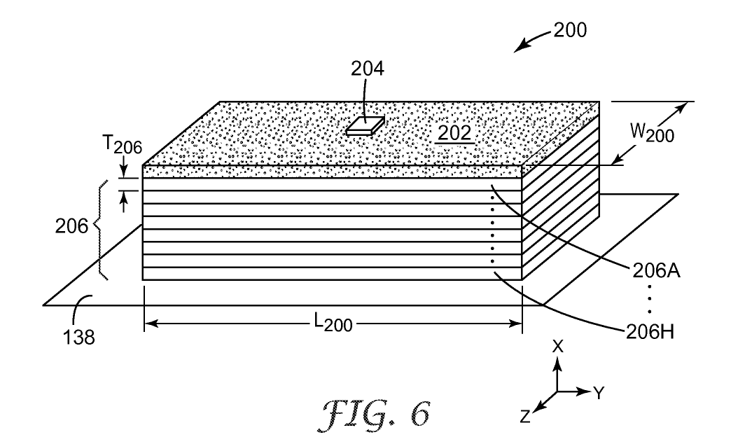

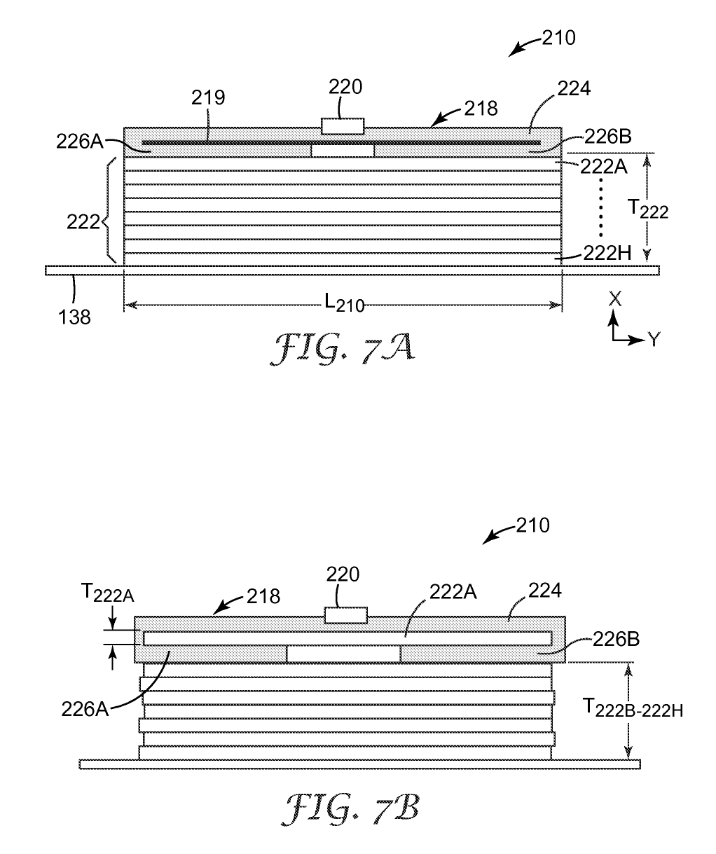

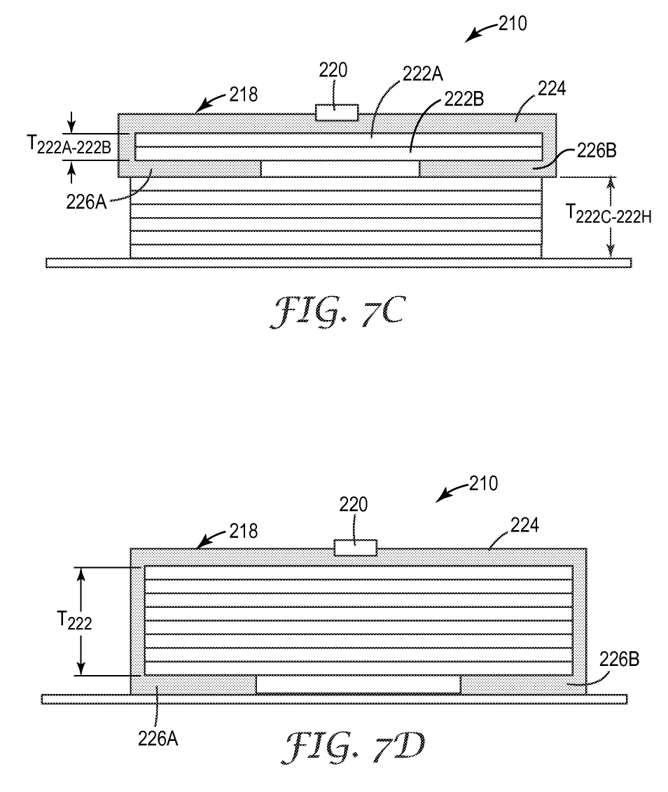

Spacer material 110 may be formed of any suitable material, including without limitation uniformly solid materials or materials incorporating voids, such as open or closed cell foams, materials incorporating bubbles such as glass bubbles and the like, or materials incorporating particulates. Suitable spacer materials 110 include relatively light weight, electrically nonconductive materials, such as, but not limited to, polycarbonate. Spacer layer 110 separates portions (or layers) 120 and 122 of antenna 108. Thickness T_{SPACER} of spacer layer 110 disposed between portions 120 and 122 of antenna 108 is an important dimension in determining a read range of RFID tag 100. In particular, a read range of antenna 108 may be the longest at a particular range of thicknesses T_{SPACER} of spacer layer 110. Spacer layer 110 is discussed in further detail in reference to FIGS. 6-7D.

Thickness T_{TAG} of RFID tag 100 depends upon many factors, including thickness T_{SPACER} of spacer material 110 disposed between portions 120 and 122 of antenna 108. Thickness T_{TAG} is preferably selected such that RFID tag 100 does not protrude significantly from an article (e.g., article 12A of FIG. 1) to which RFID tag 100 is attached. If RFID tag 100 protrudes significantly from the article, RFID tag 100 may be vulnerable to damage. Thickness T_{TAG} is also preferably selected such that antenna 108 of RFID tag 100 does not interfere significantly with components that are in close proximity to RFID tag 100. In one embodiment, thickness T_{TAG} is in a range of about 5 mm to about 8 mm.

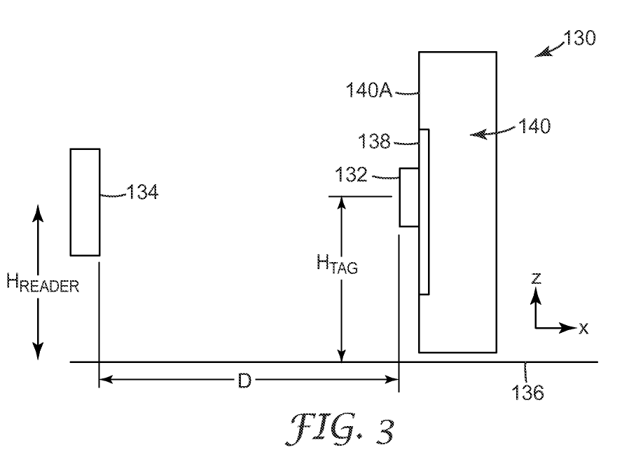

FIG. 3 is a schematic diagram of testing system 130 for testing a read range of RFID tag 132. In general, testing environment 130 includes reader 134, which was mounted on a bracket height H_{READER} above ground 136, RFID tag 132, test surface 138, and support 140. In the examples discussed below, reader 134 was a SAMSys MP9320 2.8 reader, available from Sirit, Inc. of SAMSys Technologies, Inc. of Richmond Hill, Calif., coupled to a Cushcraft S9028PS antenna, available from Cushcraft Corporation of Manchester, N.H. The transmitted power from the antenna was set to 36 dBic. The antenna of reader 134 was mounted one meter above ground 136 (i.e., H_{READER}=about 1 meter (m)).

Testing system 130 may be used to test read ranges of RFID tag 132 on both conductive and nonconductive testing surfaces 138. In the examples discussed herein, cardboard served as a nonconductive testing surface 138, while a sheet of aluminum 0.2 m long by 0.2 m wide serves as a conductive testing surface 138. Support 140 was a cardboard box that was about 1.2 m wide in the z-axis direction, about 0.3 m long in the y-axis direction (perpendicular to the plane of the image), and about 0.3 m thick in the x-axis direction.

When testing RFID tag 132 on a nonconductive test surface 138, RFID tag 132 was directly attached to support 140 with non-conductive tape such that a center of RFID tag 132 was about 1 m from ground 136 (i.e., H_{TAG}=about 1 m). When testing RFID tag 100 on a conductive testing surface 138, however, a sheet of aluminum was attached to support 140, and more particularly, a 0.2 m by 0.2 meter sheet of aluminum was centered on surface 140A of support 140. RFID tag 132 was attached to the sheet of aluminum with tape such that a center of RFID tag 132 was about 1 m from ground 136 (i.e., H_{TAG}=about 1 m).

The particular RFID tag 132 sample was then aligned with reader 134 and moved back and forth along the x-axis direction with respect to reader 134 to determine a read range of the RFID tag 132. In particular, the example determined whether reader 134 was able to read RFID tag 132 at read range distances D in order to identify a maximum read range distance D for the particular RFID tag 132 sample. Reader 134 provided a visual indicium to indicate whether RFID tag 132 was successfully energized and responsive to a read command. In the particular examples conducted, the visual indicium was a green light. RFID tag 132 was considered “read” at the particular distance D if the green light on reader 134 was on for more than 50% of the time reader 134 was attempting to interrogate RFID tag 132.

### EXAMPLE 1

In order to establish baseline measurements for purposes of comparison, a first example was conduced in which read ranges of a plurality of UHF RFID tags incorporating conventional 2D antennas having various surface areas were tested to determine a relationship between surface area of an antenna (in square millimeters (mm²)) and a read range of the RFID tag. FIG. 4 is a graph illustrating results of Example 1. In Example 1, a surface area of an antenna inlay from an ALL-9354-02 Alien RFID tag, available from Alien Technology of Morgan, Calif. was modified. For each of the data points in FIG. 4, a surface area of the RFID tag antenna was reduced by removing a 2 mm strip (along a length of the RFID tag, thereby reducing a width of the RFID tag). By removing a portion of the RFID tag, the antenna surface area was incidentally reduced. A read range of the RFID tag was then tested with testing system 130 of FIG. 3 by placing the modified RFID tag on a nonconductive cardboard testing surface 138 and interrogating the RFID tag with reader 134, which was placed at different distances D from the modified RFID tag.

It was observed that a read range of the RFID tag having a 2D antenna is directly related to surface area of the antenna. The results of the example suggest that as the antenna surface area increases, the read range increases. For example, point 150 in FIG. 4 indicates that in this example, an antenna surface area of about 777.1 mm² exhibited a read range of about 412.75 mm, while point 152 indicates that an antenna surface area of about 1282.5 mm² exhibited a read range of about 2954.02 mm (or about 2.95 meters (m)). Antenna surface areas of greater than about 1475.2 mm² (or after about point 154) exhibited read ranges that superseded the capability of the testing system 130, thus, the plot in FIG. 4 appears to plateau at a 3276.6 mm read range. However, it is believed that the read range would continue increasing for increased antenna surface areas. It is further believed that increasing the antenna surface area enables the antenna to extract more energy from an incident RF field emitted from an interrogator.

### EXAMPLE 2

Next, a second example similar to the first example was conducted to establish baseline measurements when conventional UHF RFID tags having 2D antennas are placed on conductive surfaces. The results of this example suggest that when an RFID tag is placed on an electrically conductive surface, such as titanium or aluminum alloys used in aerospace components, the conductivity of the surface may interfere with an RFID reader to interrogate the RFID tag, resulting in reduced read ranges, information corruption or erasure, or other types of RFID tag malfunctions.

In Example 2, a plurality of ALL-9354-02 Alien RFID tags having different antenna surface areas were placed on an electrically conductive testing surface 138 of testing system 130 of FIG. 3 and a read range was determined for each of the different antenna surface areas. The process from Example 1 for reducing a surface area of an RFID tag antenna and measuring the read range of the antenna was repeated with the RFID tag attached to the electrically conductive testing surface 138. In order for the RFID tag to work on a conductive testing surface 138, a 5 mm spacer layer composed of glass bubble filled epoxy material with a density of 475 kg/m³ was placed between the RFID tag and the conductive testing surface 138.

The graph shown in FIG. 5 illustrates the results of Example 2. The results suggest that a read range of an RFID tag is adversely affected when the RFID tag is placed on an electrically conductive surface. For example, at a 1282.5 mm² antenna surface area, the read range is around 321.31 mm (point 160), as compared to about 2954.02 mm on a nonconductive surface (see point 152 in FIG. 4).

Based on the results of Examples 1 and 2, an RFID tag read range may be increased by increasing the antenna surface area and by reducing the effects of a conductive surface on which the RFID tag is placed. With a conventional 2D antenna, increasing a surface area (i.e., a length and width) of the antenna in order to increase a read range of an RFID tag necessitates increasing the length and width of the RFID tag. The length and width of the RFID tag typically define a “contact surface area,” which is the surface of the RFID tag that attaches to an article to be tracked.

As 2D antenna surface areas increase in size in order to increase a read range, the available space on an article to be tracked must likewise increase in order to accommodate the larger RFID tag. However, in some applications, an article may have a limited surface area for placing an RFID tag, thus limiting the contact surface area of the RFID tag. Limiting the contact surface area of an RFID tag including a 2D antenna limits the antenna surface area. Furthermore, increasing a contact surface area of the RFID tag to increase the antenna surface area may increase the weight of the RFID tag. Increasing the surface area and/or weight of the RFID tag may be undesirable for some applications, such as aerospace applications. For example, it may be desirable to minimize the weight of some aerospace articles in order to increase the efficiency of an aircraft into which the aerospace component is incorporated. Thus, a relatively heavy RFID tag may not be practicable for aerospace applications.

An RFID tag in accordance with the present invention addresses these issues by incorporating an antenna folded into a 3D configuration into an RFID tag, thus enabling the RFID tag to include an antenna having a surface area greater than a contact surface area of the RFID tag. By folding the antenna into a 3D configuration, a size of an RFID tag may be reduced while at the same time maintaining or increasing the RFID tag read range. Or from another perspective, a read range of the RFID tag may be increased without increasing the contact surface area of the RFID tag.

An RFID tag in accordance with the present invention increases a surface area of an antenna, while maintaining a relatively lightweight and compact RFID tag structure. As a result, the RFID tag of the invention may be particularly useful for applications in which it is desirable to minimize a contact surface area and weight of the RFID tag. In addition, the RFID tag is useful for applying on electrically conductive articles because the RFID tag includes a spacer material that helps separate the antenna from the conductive surface.

### EXAMPLE 3

FIG. 6 illustrates a schematic perspective view of a 2D “baseline” RFID tag 200 that was used in a third example. FIG. 6 depicts baseline RFID tag 200 disposed on testing surface 138 of testing system 130 (shown in FIG. 3). RFID tag 200 has a length L₂₀₀ of about 50 mm and a width W₂₀₀ of about 20 mm. Thus, RFID tag 200 has a contact surface area (i.e., an area of RFID tag 200 that contacts testing surface 138) of about 1000 mm². RFID tag 200 includes antenna 202, IC chip 204, and spacer layers 206A-206H (collectively, “spacer layer 206”). An adhesive layer and outer layer similar to adhesive layer 102 and outer layer 104, respectively, of RFID tag 100 of FIG. 2 were not incorporated into RFID tag 200 for Example 3.

Antenna 202, IC chip 204, and spacer layer 206 were held together using Scotch Brand Magic Tape, which is available from 3M of St. Paul, Minn. Antenna 202 and IC chip 204 have substantially similar properties to antenna 108 of FIG. 2 and IC chip 106 of FIG. 2, respectively. Antenna 202 has a similar length and width as RFID tag 200, and thus, also has a surface area of about 1000 mm².

Spacer layer 206 was composed of polycarbonate, and a thickness T₂₀₆ of each spacer layer 206A-206H is about 0.78 mm. Thus, spacer layer 206 had a total thickness of about 6.24 mm. While eight spacer layers 206A-206H are shown, it is believed that the same experimental results discussed below may be achieved in an example testing RFID tag 200 including one or more spacer layers totaling about 6.24 mm.

In particular, a read range of the baseline RFID tag including an antenna having a surface area of about 1000 mm² was compared to the RFID tag including a folded antenna having a surface area of about 2000 mm², where both antennas were disposed in RFID tags having substantially similar dimensions and contact surface areas of about 1000 mm². It was found that a read range of an RFID tag including a folded antenna exceeded a read range of the conventional RFID tag.

In the third example, a read range of the “baseline” RFID tag 200 incorporating an unfolded, substantially 2D antenna (shown in FIG. 6) was compared to read ranges of a 3D RFID antenna in accordance with the invention (i.e., an RFID tag with a folded antenna, shown in FIGS. 7A-7D).

Also in the first example, a plurality of substantially similar RFID tags including folded antennas (folded similarly to antenna 108 of FIG. 2) were tested with testing system 130 of FIG. 3 to determine an effect a distance between first and second layers of the antenna had on a read range of the RFID tag. Thus, a spacer layer thickness between layers of the antenna differed for each of the RFID tags tested. It was found that, on both conductive or nonconductive surfaces, the read range of the RFID tag increased as the distance between antenna layers increased. On a conductive surface, however, the read range decreased as a distance between the antenna and a conductive testing surface 138 decreased.

Based on the results of the first example, it was recognized that at least two variables affect a read range for an RFID tag in accordance with the invention. The first variable is a distance between antenna layers (or otherwise stated, a total thickness of one or more spacer layers disposed between antenna layers). The second variable is the distance between the antenna and a conductive testing surface 138.

Baseline RFID tag 200 was tested with testing system 130 of FIG. 3 to determine a read range of RFID tag 200, which incorporates a 2D antenna 202 having the largest possible surface area that would fit within RFID tag 200 without folding antenna 202. The read range results are shown in Table 1. A read range of RFID tag 200 on a conductive testing surface 138 was about one-third of a read range of RFID tag 200 on a nonconductive testing surface 138.

TABLE 1
Baseline RFID Tag Read Ranges

| | Nonconductive Surface | Conductive Surface |
|---|---|---|
| Baseline RFID tag | 800 mm | 250 mm |
| (antenna surface area of | | |
| about 1000 mm²) | | |

FIGS. 7A-7D illustrate schematic cross-sectional views of 3D RFID tags 210 used in example 3. In Example 3, read ranges of a plurality of RFID tags 210 incorporating different thicknesses of spacer layer 222 disposed between first and second layers 224 and 226 of antenna 218 were tested on both conductive and nonconductive testing surfaces 138 using experimental environment 130 of FIG. 3. For purposes of illustration, FIGS. 7A-7D illustrate four of the configurations of RFID tag 210 that were tested.

In particular, FIG. 7A illustrates a schematic cross-sectional view of RFID tag 210, which is attached to testing surface 138 of experimental environment 130 of FIG. 3. RFID tag 210 includes antenna 218, IC chip 220, and spacer layers 222A-222H (collectively “spacer layer 222”). RFID tag 210 has length L₂₁₀ of about 50 mm, and a width (not shown) measured in the z-axis direction of about 20 mm. RFID tag 210 and RFID tag 200 of FIG. 6 have substantially similar contact surface areas of about 1000 mm². However, in contrast to antenna 202 of RFID tag 200, antenna 218 of RFID tag 210 has a surface area of about 2000 mm². For example, antenna 218 may have a length of about 100 mm when fully extended in the y-z plane and a width measured in the z-axis direction of about 20 mm. As shown below, RFID tag 210 has a greater read range capability than RFID tag 200.

In order to fit antenna 218 within RFID tag 210, antenna 218 is folded in an x-axis direction such that the folded antenna 218 has a length of about 50 mm. First layer 224 and second layer 226 are defined by folding antenna 218. Second layer 226 is comprised of segments 226A and 226B, which do not contact one another. No spacer layer 222 separates first and second layers 224 and 226 of antenna 218. Thus, spacer layer 222 having thickness T₂₂₂ equal to about 6.24 mm is disposed between antenna 218 and testing surface 138.

Antenna 218 and IC chip 220 have substantially similar properties to antenna 108 of FIG. 2 and IC chip 106 of FIG. 2, respectively. Spacer layer 222 is substantially similar to spacer layer 206 of FIG. 6 and has the same dimensions as spacer layer 206.

FIGS. 7B-7D illustrate schematic cross-sectional views of RFID tag 210, where first and second layers 224 and 226 of antenna 218 are separated from each other by different thickness of spacer layer 222. In FIG. 7B, spacer layer 222A having a thickness T_{222A} of about 0.78 mm separates first and second layers 224 and 226 of antenna 218. Thus, spacer layers 222B-222H having a total thickness T_{222B-222H} of about 5.46 mm separates antenna 218 from testing surface 138. Thus the overall thickness of RFID tag 210 has not changed from FIG. 7A to FIG. 7B.

In FIG. 7C, two spacer layers 222A and 222B having a total thickness T_{222A-222B} of about 1.56 mm separates first and second layers 224 and 226 of antenna 218. Thus, spacer layers 222C-222H having a total thickness T_{222C-222H} of about 4.68 mm separates antenna 218 from testing surface 138. Finally, in FIG. 7D, first and second layers 224 and 226 of antenna 218 are separated by eight spacer layers 222A-222H. Thus, first and second layers 224 and 226 are separated by a distance T₂₂₂ of about 6.24 mm, and the second layer 226 of antenna 218 is directly adjacent to testing surface 138.

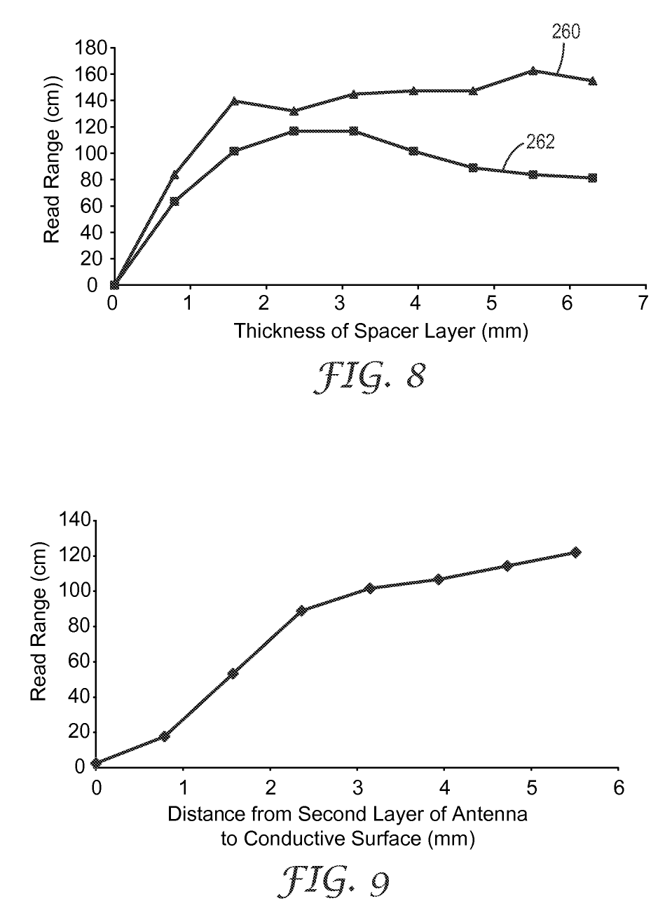

FIG. 8 is a graph illustrating a relationship between a thickness of spacer layer 222 disposed between first layer 224 and second layer 226 of folded antenna 218, and a read range of RFID tag 210. Line 260 illustrates the experimental results when testing surface 138 was cardboard, and thus, nonconductive. Line 260 indicates that when RFID tag 210 was placed on a nonconductive testing surface 138, a read range of RFID tag 210 generally increased as spacer layer 222 thickness increased until a thickness of spacer layer 222 exceeded about 5 mm. When first and second layers 224 and 226 of antenna 218 were essentially adjacent to each other (i.e., seperated only by adhesive layer 219 having a thickness of less than 0.25 mm), a read range was about 0 cm. It is believed that the 0 cm read range is attributable to interference between layers 224 and 226 of antenna 218.

Line 262 illustrates the experimental results when testing surface 138 was aluminum foil, and thus, conductive. A read range of RFID tag 210 increased as a thickness of spacer layer 222 disposed between first and second layers 224 and 226 of antenna 218 is increased from 0 mm to about 2.36 mm. The read range decreased after the thickness of spacer layer 222 was increased to greater than about 3.15 mm. This may be attributable to the fact that as a thickness of spacer layer 222 disposed between first and second layers 224 and 226 of antenna 218 increased, the distance separating the second layer 226 of antenna 218 and the conductive testing surface 138 decreased. As previously discussed, when RFID tag 210 is placed on a conductive surface, the conductive surface may interfere with the communication between RFID tag 210 and an interrogator.

FIG. 9 is a graph illustrating a relationship between a distance between second layer 226 of folded antenna 218 and a conductive testing surface 138. A distance between layers 224 and 226 of antenna 218 remained constant at 2.4 mm while a distance between second layer 226 and conductive testing surface 138 was varied by altering the thickness of spacer layer 222 disposed between second layer 226 and conductive testing surface 138. As FIG. 9 indicates, the read range of RFID tag 210 increased as a distance between second layer 226 of antenna 218 and conductive testing surface 138 increased. The experimental data in FIGS. 8 and 9 suggests that a desired read range may be achieved by balancing the separation between first and second layers 224 and 226 of antenna 218 and the separation between second layer 226 of antenna 218 and a conductive testing surface 138.

As shown in Table 2, an appropriately configured RFID tag may exhibit much greater maximum read ranges (based on data from FIG. 8) than RFID tag 200 of FIG. 6 on both conductive and nonconductive testing surfaces 138. Table 2 also indicates that the surface on which an RFID tag is placed has less of an effect on RFID tag 210 incorporating folded antenna 218 than on RFID tag 200 with a 2D antenna.

TABLE 2
Baseline RFID Tag 200 Read Range v. RFID Tag 210 Read Range

| | Nonconductive Surface | Conductive Surface |
|---|---|---|
| Baseline RFID tag | 80 mm | 25 mm |
| (antenna surface area of | | |
| about 1000 mm²) | | |
| RFID Tag 210 (antenna | 1620 mm | 1180 mm |
| surface area of about | | |
| 2000 mm²) | | |

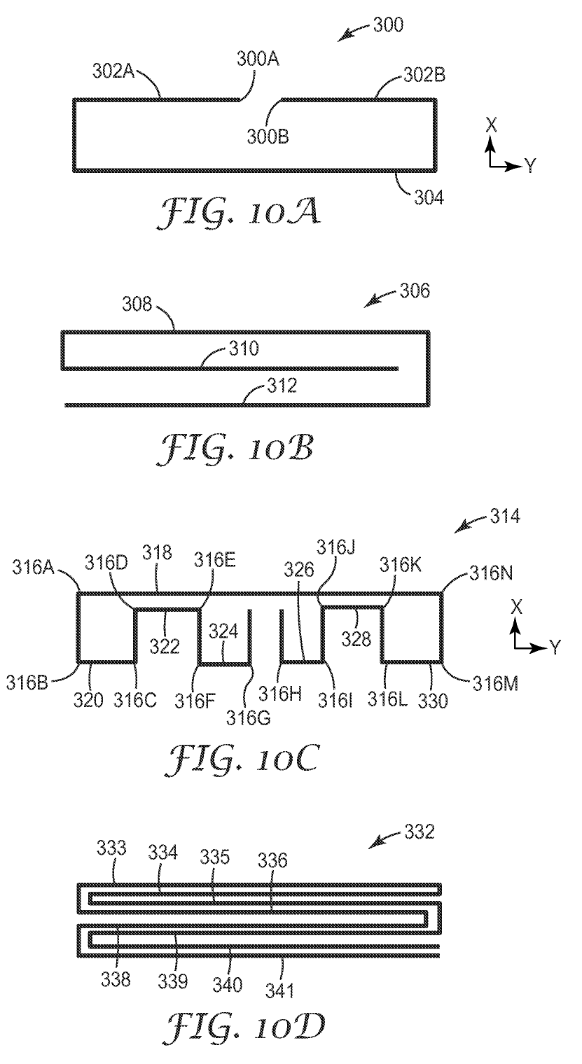

In an RFID tag in accordance with the present invention, an antenna surface area is maximized while maintaining a relatively compact RFID tag structure by folding the antenna, thereby defining a plurality of antenna layers, which are separated by a spacer material. An antenna may be folded into many different configurations. For example, other suitable antenna configurations are shown in FIGS. 10A-10D. The antenna configurations shown in FIGS. 10A-10D represent four of the many possible antenna configurations that are within the scope of the invention, and the invention is not limited to the particular antenna configurations shown herein. Rather, an antenna may be folded into any configuration that enables the antenna to fit within an RFID tag having a desired size. For example, while the antenna configurations shown in FIGS. 10A-10D illustrate right angle (90°) folds (e.g., folds 316A-316N in FIG. 10C), an antenna configuration in accordance with the invention may include folds that are less than or greater than 90° or folds that are curvilinear in cross-section.

FIG. 10A is a schematic cross-sectional view of antenna 300, which extends between proximal end 300A and distal end 300B when fully extended. Antenna 300 is folded in an x-axis direction, thereby defining first layer 302 (including segments 302A and 302B) and second layer 304. Antenna 300 is folded in a configuration similar to antenna 210 of FIGS. 7A-7D, except that proximal and distal ends 300A and 300B, respectively, are in first layer 302 of antenna, rather than second layer 304. As with RFID tag 100 of FIG. 2, a surface area of antenna 300 may be up to two times the contact surface area of an RFID tag into which antenna 300 is incorporated because antenna 300 is essentially folded in half.

FIG. 10B is a schematic cross-sectional view of antenna 306, which is folded to define three layers 308, 310, and 312 that substantially reside in different y-z planes. “Substantially reside” in a y-z plane indicates that a layer is closer to being substantially parallel to the y-z plane than to being substantially perpendicular to the y-z plane, and does not necessarily mean that the layer is parallel to the y-z plane. A spacer material may separate two or more layers 308, 310, and 312. A surface area of antenna 306 may be up to three times the contact surface area of an RFID tag into which antenna 306 is incorporated because antenna 306 is essentially folded into thirds. Thus, the configuration of antenna 306 enables an RFID tag with an antenna of surface area at least equal to the surface area of antenna 300 of FIG. 10A to occupy even less space on an article than an RFID tag incorporating antenna 300 of FIG. 10A.

FIG. 10C is a schematic cross-sectional view of antenna 314, which is folded in multiple regions 316A-316N to define seven layers 318, 320, 322, 324, 326, 328, and 330 that substantially reside in different y-z planes. A spacer material may separate two or more layers 318, 320, 322, 324, 326, 328, and 330. In alternate embodiments, antenna 314 may be folded at any number of regions to define any suitable number of layers that substantially reside in a y-z plane. In one embodiment, layers 318, 320, 322, 324, 326, 328, and 330 may be substantially parallel to an article surface, while in another embodiment, layers 318, 320, 322, 324, 326, 328, and 330 may be substantially perpendicular to the article surface.

FIG. 10D is a schematic cross-sectional view of antenna 332, which is folded in multiple regions (not labeled) to define eight layers 333-336 and 338-341 that substantially reside in the y-z plane. A spacer material may separate two or more layers 333-336 and 338-341. In one embodiment, layers 333-336 and 338-341 are substantially parallel. As with antenna 314 of FIG. 10C, layers 333-336 and 338-341 may be substantially parallel to an article surface, while in another embodiment, layers 333-336 and 338-341 may be substantially perpendicular to the article surface. In alternate embodiments, an antenna may be folded in a similar manner as antenna 332 to define any suitable number of layers that substantially reside in the y-z plane. A surface area of antenna 332 may be up to eight times the contact surface area of an RFID tag into which antenna 332 is incorporated because antenna 332 is essentially folded into eighths. Thus, the configuration of antenna 332 enables an RFID tag to occupy even less space on an article than an RFID tag incorporating antenna 300 of FIG. 10A.

### EXAMPLE 4

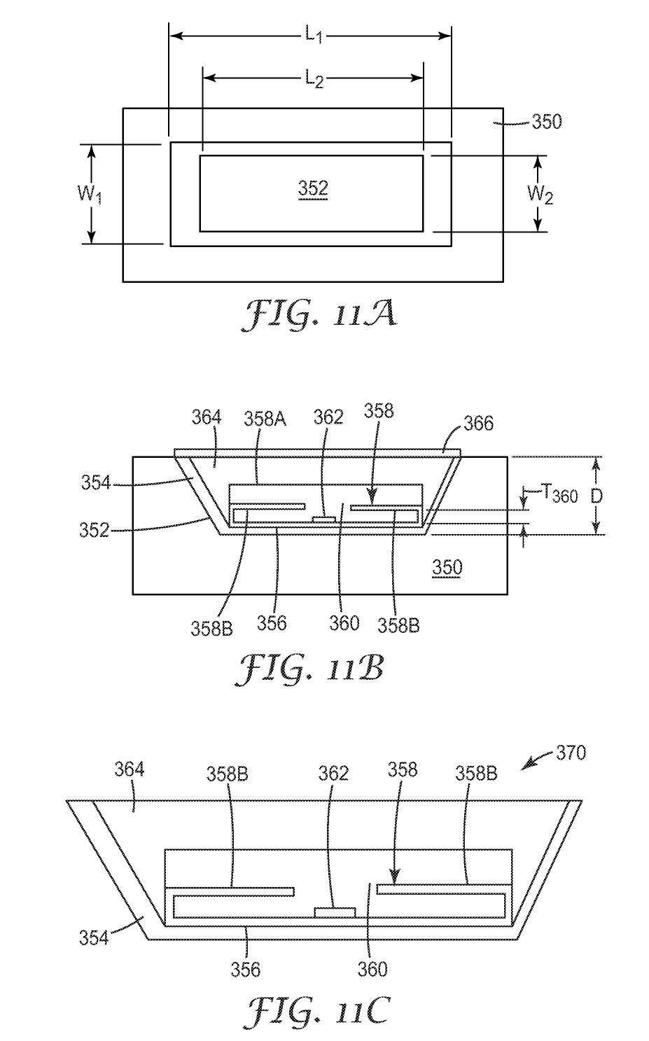

In a fourth example, read ranges of functional RFID tags incorporating folded antennas were compared. In this example, tags complete with adhesive layer and protective film were made. The antennas used were as in Examples 1-3. FIGS. 11A-11B illustrate different steps of a technique that was used to construct each of the functional RFID tags 370 (shown in FIG. 11C) that was tested in Example 4. The details of the technique described herein are only used to provide a general description of the technique that was used to form the functional RFID tag 370 for the fourth example. Further details of the technique for constructing an RFID tag is described in commonly assigned U.S. Provisional Patent Application No. 60/824149 attorney docket number 62294US002, entitled “RFID TAG AND METHOD OF MAKING THE SAME”, filed concurrently herewith, hereby incorporated by reference.

FIG. 11A is a plan view of vacuum forming mold 350 defining cavity 352, which was used to construct the sample RFID tags 370 (shown in FIG. 11C). FIG. 11B is another plan view of vacuum forming mold 350, where protective film 354, resin 356, antenna 358, spacer material 360, IC chip 362, and polyurethane resin 364 are disposed in cavity 352. As shown in FIGS. 11A and 11B, vacuum forming mold 350 defines cavity 352 having depth D of about 6 mm. Cavity 352 narrows from length L₁ of about 110 mm and width W₁ of about 25 mm to length L₂ of about 100 mm and width W₂ of about 20 mm. Disposed within cavity is protective film 354, which is an aerospace fluoropolymer available from 3M of St. Paul, Minn. In a vacuum environment, protective film 354 was placed over mold 350, and protective film 354 was drawn into cavity 352 to form a molding by applying heat to soften protective film 354. A small amount of pre-mixed polyurethane resin 356 was placed in the bottom of mold 350 over protective film 354.

An assembly including antenna 358, spacer material 360, and IC chip 362 was then pressed into polyurethane resin 356. Antenna 358 was folded to define first layer 358A and second layer 358B (which includes two segments). The assembly included a predetermined thickness T₃₆₀ of spacer material 360 separating first layer 358A and second layer 358B of antenna 358. More specifically, the technique shown in FIGS. 11A and 11B was used to form RFID tags 370 having thicknesses T₃₆₀ of 0.1 mm, 0.78 mm, 1.54 mm, 2.36 mm, and 3.93 mm.

After antenna 358, spacer material 360, and IC chip 362 were pressed into polyurethane resin 356, cavity 352 was filled with more polyurethane resin 364. A sheet of pressure sensitive adhesive (PSA) 366 on a release liner was placed over cavity 352 and excess resin 364 protruding past cavity 352 was trimmed. Resin 356 and 364 were cured prior to removing RFID tag 370 (FIG. 11C) from mold 350 by releasing the vacuum.

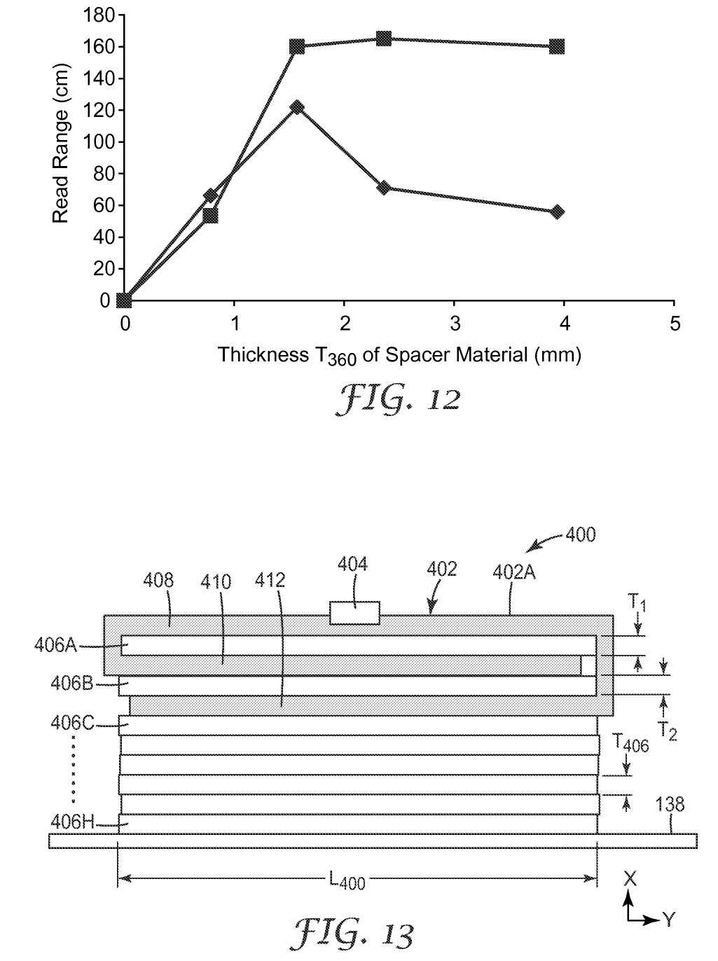

FIG. 11C illustrates a perspective view of RFID tag 370, which was formed using the technique described in reference to FIGS. 11A-11B. Read ranges of a plurality of RFID tags 370 including different thicknesses T₃₆₀ (specifically, 0.1 mm, 0.78 mm, 1.54 mm, 2.36 mm, and 3.93 mm) were tested with testing system 130 on both conductive and nonconductive testing surfaces 138. FIG. 12 is a graph illustrating the results of Example 4, and illustrates a relationship between thickness T₃₆₀ of spacer material 360 and a read range of RFID tag 370.

Due to the thickness of polymer film 354 and resin 356, the dimension of spacer material 360 does not correspond to the results of Example 3. However, the data points shown in FIG. 12 indicate that the data from Example 4 is consistent with the data from Example 3. In Example 4, when RFID tag 370 was placed on a nonconductive testing surface 138, the read range of RFID tag 370 generally increased as thickness T₃₆₀ of spacer material 360 increased from about 0 mm to about 2.36 mm. The read range of RFID tag 370 decreased slightly from about 165.1 mm at thickness T₃₆₀ of about 2.36 mm to a read range of about 160.2 cm at thickness T₃₆₀ of about 3.94 mm.

When RFID tag 370 was placed on a conductive testing surface 138, the read range increased as thickness T₃₆₀ of spacer material 360 between layers 358A and 358B of antenna 358 increased from 0 mm to about 1.57 mm, and decreased thereafter. More specifically, at a thickness T₃₆₀ of about 2.36 mm, the read range was about 71.12 cm, while at a thickness T₃₆₀ of about 1.57 mm, the read range was about 121.92 cm.

### EXAMPLE 5

In a fifth example, a read range of RFID tag 400 (FIG. 13) incorporating another 3D antenna configuration was tested. The antennas used were as in Examples 1-4. FIG. 13 is a schematic cross-sectional view of RFID tag 400 disposed on testing surface 138 of testing system 130 of FIG. 3. RFID tag 400 includes antenna 402, which is folded into a configuration shown in FIG. 10B, IC chip 404, and spacer layers 406A-406H (collectively “spacer layer 406”). Although not shown in FIG. 13, RFID tag 400 may also include an adhesive layer and/or a protective layer similar to adhesive layer 102 and protective layer 104, respectively, of RFID tag 100 of FIG. 2. RFID tag 400 has a length L₄₀₀ of about 25 mm and a width measured in the y-z plane of about 20 mm. Thus, RFID tag 400 has a contact surface area (i.e., an area of RFID tag 400 that contacts testing surface 138) of about 500 mm².

Antenna 402 and IC chip 404 have substantially similar properties to antenna 108 and IC chip 106 of FIG. 2, respectively. Antenna 402 has a surface area of about 1000 mm² and is folded into the configuration shown in FIG. 10B, thereby defining layers 408, 410, and 412. Spacer layer 406 is composed of polycarbonate, and a thickness T₄₀₆ of each spacer layer 406A-406H is about 0.78 mm. Thus, spacer layer 406 has a total thickness of about 6.24 mm. In the embodiment shown in FIG. 13, a single spacer layer 406A having a thickness of about 0.78 mm is disposed between layers 408 and 410 of antenna 402, while spacer layer 406B having a thickness of about 0.78 mm is disposed between layers 410 and 412. Thus, thickness T₁ between layers 408 and 410, and thickness T₂ between layers 410 and 412 are both about 0.78 mm.

In Example 5, a plurality of RFID tags 400 having different thicknesses T₁ and T₂ of spacer layer 406 were tested using testing system 130 of FIG. 3 to determine an effect of thicknesses T₁ and T₂ on read range of RFID tag 400. In each RFID tag 400, a distance between testing surface 138 and top surface 402A of antenna 402 was kept constant at 6.24 mm.

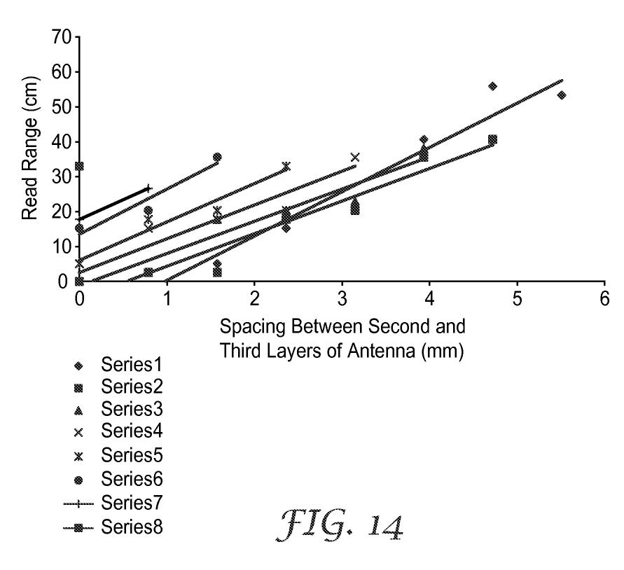

FIG. 14 is a graph illustrating results of the fifth example. The read ranges of RFID tags 400 on a nonconductive testing surface 138 are not shown in FIG. 14 because it was found that the read ranges were negligible when RFID tag 400 was placed on a nonconductive testing surface 138.

A series of eight tests were conducted in Example 5 (Series 1-8 in FIG. 14). In each series, thickness T₁ between layers 408 and 410 remained constant, while thickness T₂ between layers 410 and 412 was modified. For example, in Series 1, a single spacer layer 406A was disposed between layers 408 and 410 of antenna 402, while the number of remaining spacer layers 406B-406H disposed between layers 410 and 412 were gradually increased. In Series 2, spacer layers 406A and 406B were disposed between layers 408 and 410 of antenna 402, while the number of remaining spacer layers 406C-406H disposed between layers 410 and 412 were gradually increased. In each of Series 3-8, the number of spacer layers 406A-406H between layers 408 and 410 was increased by one spacer layer 406A-406H, and remained constant throughout the series, while the number of remaining spacer layers 406A-406H that were disposed between layers 410 and 412 changed. Each line in FIG. 14 represents a distance between layers 408 and 410 (i.e., thickness T₁).

The results of the fifth example shown in FIG. 14 suggests that within the series that were tested, a greatest read range of RFID tag 400 is achieved when thickness T₁ between layers 408 and 410 is about 0.78 mm (i.e., a single spacer layer 406A) and thickness T₂ between layers 410 and 412 is between about 4 mm and 5 mm.

The dimensions and orthogonal x-y-z axes provided and referenced herein are for illustrative purposes only and are not intended to limit the scope of the invention in any way. Various embodiments of the invention have been described. These and other embodiments are within the scope of the following claims.

We claim:

1. A radio frequency identification (RFID) tag comprising:
a three-dimensional (3D) antenna comprising at least a first antenna layer and a second antenna layer, wherein the first antenna layer and the second antenna layer each define two-dimensional (2D) conductive surfaces substantially residing in different planes of the RFID tag, and wherein electrical current flows between the first antenna layer and the second antenna layer if the tag is in the presence of an electromagnetic field; and
a layer of spacer material between the first and second layers of the antenna.

2. The RFID tag of claim 1, wherein the antenna is folded to define the first and second antenna layers.

3. The RFID tag of claim 1, wherein a first end and a second end of the antenna reside in different planes of the RFID tag.

4. The RFID tag of claim 1, wherein the first layer and second layer of the antenna are substantially parallel.

5. The RFID tag of claim 1, the first and second layers of the antenna are separated by a distance of about 0.5 to about 10 millimeters.

6. The RFID tag of claim 1, wherein the antenna comprises:
a first fold and second fold defining the first layer;
a third and fourth fold defining the second layer, wherein the second layer comprises:
a first segment, wherein a first end of the antenna is disposed in the first segment; and
a second segment, wherein a second end of the antenna is disposed in the second segment, and wherein the first end of the antenna is separated from the second end; and
wherein the first and third folds further define a third layer extending between the first and second layers, and the second and fourth folds further define a fourth layer extending between the first and second layers.

7. The RFID tag of claim 1, wherein the antenna is folded to define at least the first layer, the second layer, and a third layer substantially residing in different planes.

8. The RFID tag of claim 1, wherein the RFID tag has a total thickness of about 3 to about 10 millimeters.

9. The RFID tag of claim 1, wherein the antenna is a dipole antenna.

10. The RFID tag of claim 9, wherein the lengths of the first layer and the second layer are each less than about 150 millimeters.

11. The RFID tag of claim 1, wherein the spacer material is composed at least in part of at least one of a glass-bubble filled epoxy material and polycarbonate.

12. The RFID tag of claim 1, wherein the layer of spacer material is comprised of a plurality of layers of spacer material.

13. The RFID tag of claim 1 further comprising:
a protective outer layer adjacent to the first layer of the antenna.

14. The RFID tag of claim 1 further comprising an adhesive layer for adhering the RFID tag to an article surface.

15. The RFID tag of claim 1, wherein the layer of spacer material separating the first layer and the second layer is a first layer of spacer material, and the RFID tag further comprises:
a second layer of spacer material configured to separate the antenna from an article surface when the RFID tag is placed on the article surface.

16. The RFID tag of claim 1, the antenna having an antenna surface area, wherein a contact surface area of the RFID tag is less than the antenna surface area.

17. The RFID tag of claim 1, wherein the antenna is composed in part of at least one of copper, aluminum, or a magnetic metal alloy.

18. A system comprising:
a radio frequency identification (RFID) tag comprising:
a contact surface having a contact surface area;
an antenna folded into a three-dimensional configuration to define a plurality of antenna portions, wherein an antenna surface area of the antenna is greater than the contact surface area of the contact surface; and
at least one layer of electrically nonconductive spacer material separating at least two of the antenna portions; and
a reader unit for interrogating the RFID tag to obtain information from the RFID tag.

19. The system of claim 18, wherein the layer of spacer material separating the first layer and the second layer is a first layer of spacer material, and the RFID tag further comprises:
a second layer of spacer material configured to separate the antenna from an article surface when the RFID tag is placed on the article surface.

20. A method for forming a radio frequency identification (RFID) tag, the method comprising:
folding an antenna to define at least two antenna layers, each antenna layer defining a two-dimensional (2D) conductive surface; and
separating the at least two antenna layers with a spacer material.
